(19) United States
(12) Patent Application Publication
(10) Pub. No.: US 2020/0011605 A1
(43) Pub. Date: Jan. 9, 2020

(54) HEAT EXCHANGER MANUFACTURING METHOD, HEAT EXCHANGER STACKING METHOD, HEAT EXCHANGER, AND MULTI-ROW HEAT EXCHANGER

(71) Applicant: Hitachi-Johnson Controls Air Conditioning, Inc., Tokyo (JP)

(72) Inventors: Takeshi ENDO, Tokyo (JP); Mamoru Houfuku, Tokyo (JP); Nagatoshi Oki, Tokyo (JP); Shuuhei Tada, Tokyo (JP)

(21) Appl. No.: 16/572,803

(22) Filed: Sep. 17, 2019

Related U.S. Application Data
(63) Continuation of application No. PCT/JP2018/021327, filed on Jun. 4, 2018.

(30) Foreign Application Priority Data
Jul. 21, 2017 (JP) 2017-141430

(51) Int. Cl. F28D 1/047; B23K 1/00; F28F 1/32; F28F 9/26; F28F 1/04; F28F 1/02; F28F 9/02

(52) U.S. Cl. CPC F28D 1/0471; B23K 1/0012; F28F 1/32; F28F 9/268; B23K 2101/14; F28F 1/022; F28F 9/0243; F28F 2275/045; F28F 1/04

(57) ABSTRACT

Manufacturing a heat exchanger by brazing of multiple heat transfer pipes, multiple fins, and headers. The multiple heat transfer pipes joined to each fin with the heat transfer pipes each being inserted into cutout recessed portions as cutouts of side portions of the fins on one side. The headers each joined to both end portions of each heat transfer pipe to couple the multiple heat transfer pipes and having internal spaces for collecting or distributing fluid flowing in the multiple heat transfer pipes. A protruding length Tf of each fin from a corresponding one of the heat transfer pipes and a distance Th from each heat transfer pipe to an outer surface of a corresponding one of the headers on the same side as a protrusion are substantially equal to each other.

### CROSS-REFERENCE TO RELATED APPLICATION

The present application is a continuation application of International Application No. PCT/JP2018/021327, filed Jun. 4, 2018, which claims priority to Japanese Patent Application No. 2017-141430, filed Jul. 21, 2017. The contents of these applications are incorporated herein by reference in their entirety.

### BACKGROUND

### 1. Technical Field

The present disclosure relates to a heat exchanger manufacturing method, a heat exchanger stacking method, a heat exchanger, and a multi-row heat exchanger.

### 2. Related Art

A background art in the art includes JP-A-2015-55398. This publication describes that after a heat exchanger body (80), a header pipe assembly (70), and a connection pipe (110, 120, 130) have been temporarily assembled together, a main pipe portion (111, 121, 131) and two branched pipe portions (112a, 112b, 122a, 122b, 132a, 132b) are joined to each other by furnace brazing in a state in which two branched pipe portions (112a, 112b, 122a, 122b, 132a, 132b) are arranged horizontally (see the Abstract).

### SUMMARY

A heat exchanger manufacturing method according to an embodiment of the present disclosure is a method for manufacturing a heat exchanger by brazing of multiple heat transfer pipes, multiple fins, and headers, the heat exchanger including the multiple fins arranged in a thickness direction, the multiple heat transfer pipes joined to each fin with the heat transfer pipes each being inserted into cutout recessed portions as cutouts of side portions of the fins on one side, and the headers each joined to both end portions of each heat transfer pipe to couple the multiple heat transfer pipes and having internal spaces for collecting or distributing fluid flowing in the multiple heat transfer pipes, the method including: a first step of assembling the heat transfer pipes, the fins, and the headers to form an assembled member and setting such that a protruding length Tf of each fin from a corresponding one of the heat transfer pipes and a distance Th from each heat transfer pipe to an outer surface of a corresponding one of the headers on the same side as a protrusion are substantially equal to each other; a second step of placing, after the first step, the assembled member on a conveyer with the protruding length Tf side and the distance Th side facing down; and a third step of conveying, after the second step, the assembled member into a furnace by the conveyer to heat the assembled member, thereby performing brazing of the assembled member.

### BRIEF DESCRIPTION OF THE DRAWINGS

FIGS. 1A and 1B are perspective views FIG. 1A of an entire configuration of a heat exchanger as a first embodiment of the present disclosure and a side view FIG. 1B illustrating a situation where a heat transfer pipe is inserted into a fin.

FIG. 2 is a front view of a main portion in a state in which the heat exchanger is placed on a conveyer at a manufacturing step in the first embodiment of the present disclosure.

FIGS. 3A-3C are perspective views FIGS. 3A and 3B of a configuration example of a header of a heat exchanger as a second embodiment of the present disclosure and a front view FIG. 3C illustrating a state in which the heat exchanger is placed on a conveyer at a manufacturing step.

FIG. 4 is a front view of a main portion in a state in which the heat exchanger is placed on the conveyer at the manufacturing step, FIG. 4 illustrating a variation of the second embodiment of the present disclosure.

FIG. 5 is a front view of the main portion in a state in which the heat exchanger is placed on the conveyer at the manufacturing step, FIG. 5 illustrating another variation of the second embodiment of the present disclosure.

FIG. 6 is a perspective view of a main portion of a heat exchanger as a third embodiment of the present disclosure.

FIGS. 7A and 7B are front views FIGS. 7A and 7B of a main portion of a multi-row heat exchanger as a fourth embodiment of the present disclosure.

FIGS. 8A and 8B are perspective view FIG. 8A and an upper view FIG. 8B of the entirety of the multi-row heat exchanger as the fourth embodiment of the present disclosure.

FIGS. 9A and 9B are front views FIGS. 9A and 9B of a main portion of a variation of the multi-row heat exchanger as the fourth embodiment of the present disclosure.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

A heat exchanger has been known, which includes multiple plate-shaped fins arranged in parallel, heat transfer pipes provided at the fins, and headers coupling heat transfer pipe end portions. For manufacturing such a heat exchanger, furnace brazing is performed with these members being temporarily assembled, and therefore, the heat exchanger in a lying state is placed on a conveyer. However, in this case, there is such a defect that the fins, the heat transfer pipes, or the headers are brazed in a state shifted from original positions depending on the degree of load application due to the way to bring the fins and the headers into contact with a conveyer surface. For this reason, an object of the present embodiment is to provide a heat exchanger manufacturing method and a heat exchanger configured such that each member is less shifted from an original position even upon joint by furnace brazing.

To solve the above-described problem, an embodiment of the present disclosure is a heat exchanger manufacturing method for manufacturing a heat exchanger by brazing of multiple heat transfer pipes, multiple fins, and headers. The heat exchanger includes the multiple fins arranged in a thickness direction, the multiple heat transfer pipes joined to each fin with the heat transfer pipes each being inserted into cutout recessed portions as cutouts of side portions of the fins on one side, and the headers each joined to both end portions of each heat transfer pipe to couple the multiple heat transfer pipes and having internal spaces for collecting or distributing fluid flowing in the multiple heat transfer pipes. The method includes: a first step of assembling the heat transfer pipes, the fins, and the headers to form an assembled member and setting such that a protruding length Tf of each fin from a corresponding one of the heat transfer pipes and a distance Th from each heat transfer pipe to an outer surface of a corresponding one of the headers on the same side as a protrusion are substantially equal to each other; a second step of placing, after the first step, the assembled member on a conveyer with the protruding length Tf side and the distance Th side facing down; and a third step of conveying, after the second step, the assembled member into a furnace by the conveyer to heat the assembled member, thereby performing brazing of the assembled member.

According to the present embodiment, the method for manufacturing the heat exchanger configured such that each member is less shifted from the original position even upon joint by furnace brazing can be provided. Other objects, configurations, and advantageous effects than those described above will be apparent from description of embodiments below.

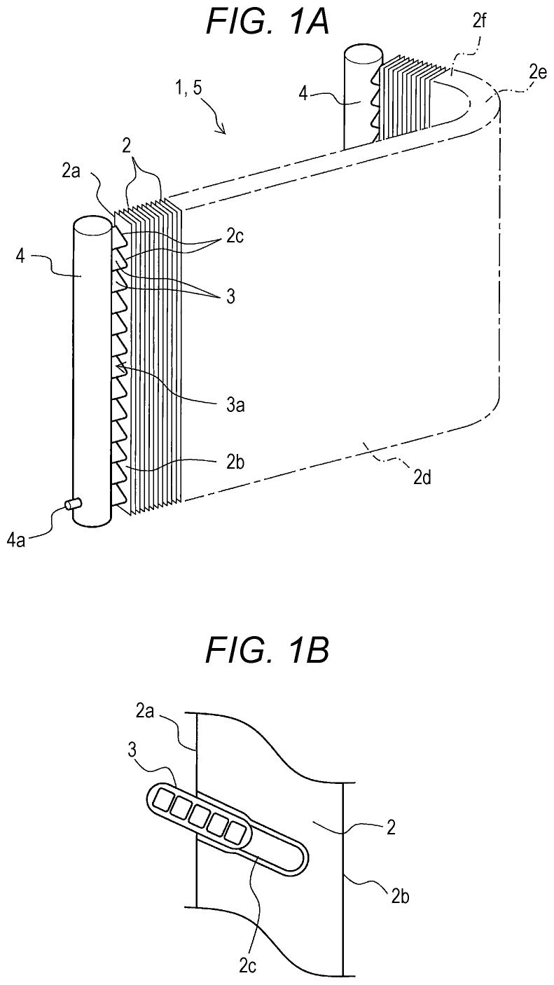

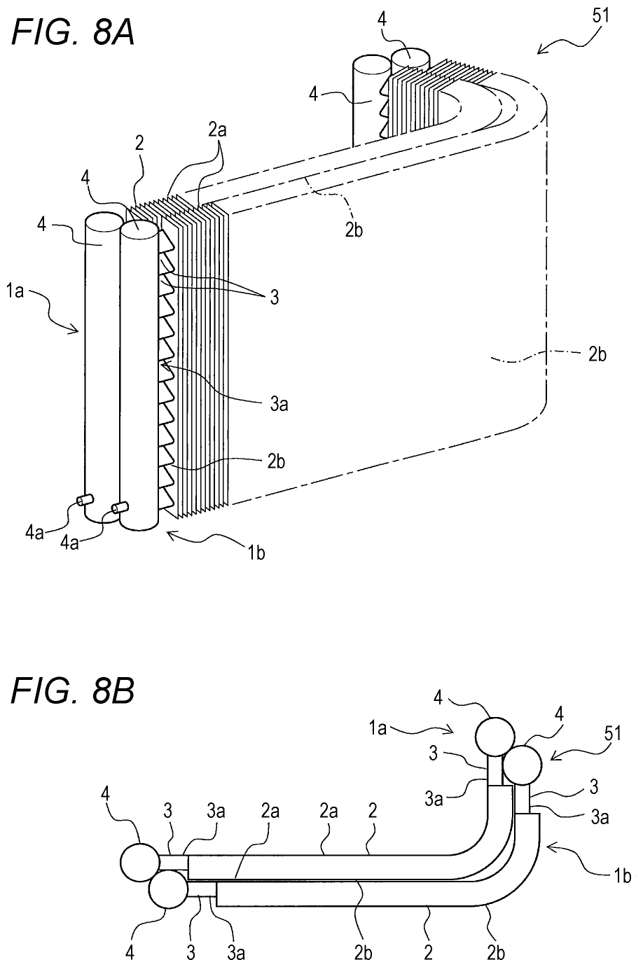

Hereinafter, embodiments of the present disclosure will be described with reference to the drawings. Note that only main portions are illustrated in each figure for the sake of convenience of description, except for FIGS. 1A, 8A, and 8B.

### First Embodiment

FIG. 1A is a perspective view of a heat exchanger as one embodiment of the present disclosure. A heat exchanger 1 of the present embodiment includes many plate-shaped fins 2 arranged in a thickness direction. Heat transfer pipes (flat pipes) 3 having, e.g., a flat section in a radial direction are joined to each fin 2 with each heat transfer pipe 3 being inserted into a cutout recessed portion 2c as a cutout of one side portion 2a of each fin 2 (also see FIG. 1B). Thus, the fin 2 protrudes from the heat transfer pipe 3 on one side of each fin 2 (a protruding portion 2b), but does not protrude from the heat transfer pipe 3 on the other side (the side portion 2a). The heat transfer pipe 3 is configured such that a longitudinal direction thereof is substantially perpendicular to a plate width direction of each fin 2. The multiple heat transfer pipes 3 are, for example, arranged at equal intervals in an upper-to-lower direction. Moreover, in this example, the heat transfer pipes 3 are equally inclined downward toward a windward side in the flow of air targeted for heat exchange with fluid (refrigerant) flowing in the heat exchanger 1.

Tubular headers 4 are each arranged at both end portions of each of the multiple heat transfer pipes 3. An end portion of each heat transfer pipe 3 is joined to the header 4 with the heat transfer pipe 3 being inserted into the header 4. Each header 4 has an internal space for collecting or distributing fluid flowing in the multiple heat transfer pipes 3 such that the heat transfer pipes 3 are coupled to each other. A fluid outlet/inlet pipe 4a for fluid is provided at a side portion of the header 4. A section 3a of the heat transfer pipe 3 where no fins 2 are provided across a predetermined distance is present between each header 4 and the fin 2. Moreover, FIG. 1 illustrates an example where arrangement of the heat transfer pipes 3 and the fins 2 is curved in an L-shape. This is a completed product, and arrangement of the heat transfer pipes 3 and the fins 2 is in a linear shape upon the process of assembling the heat transfer pipes 3, the fins 2, and the headers 4.

For manufacturing the heat exchanger 1, these members are, for furnace brazing, placed in a temporarily-assembled state with these members lying on a conveyer. However, in this case, there is such a defect that the fins 2, the heat transfer pipes 3, and the headers 4 are brazed in a state shifted from an original position relationship depending on the degree of load application due to the way to bring the fins 2 and the headers 4 into contact with a conveyer surface.

Specifically, the header 4 includes structures such as a fluid distribution structure and a path coupling pipe, and therefore, deformation force is sometimes applied to the temporarily-assembled heat exchanger 1 due to a mass increase or generation of moment force. In the case of a structure in which a fin 2 side has a cutout recessed portion 2c for inserting the heat transfer pipe 3 from a surface direction of the fin 2, an opening end of the cutout recessed portion 2c is present. Thus, tendency shows that stiffness of the fin 2 itself is low or the fin becomes more sensitive to thermal deformation upon heating due to influence of residual stress at the point of insertion of the heat transfer pipes 3 into the fins 2 and the headers 4 upon temporal assembly. For these reasons, the structure of the heat exchanger 1 less causing deformation even when furnace brazing is performed and the method for manufacturing such a heat exchanger 1 will be described.

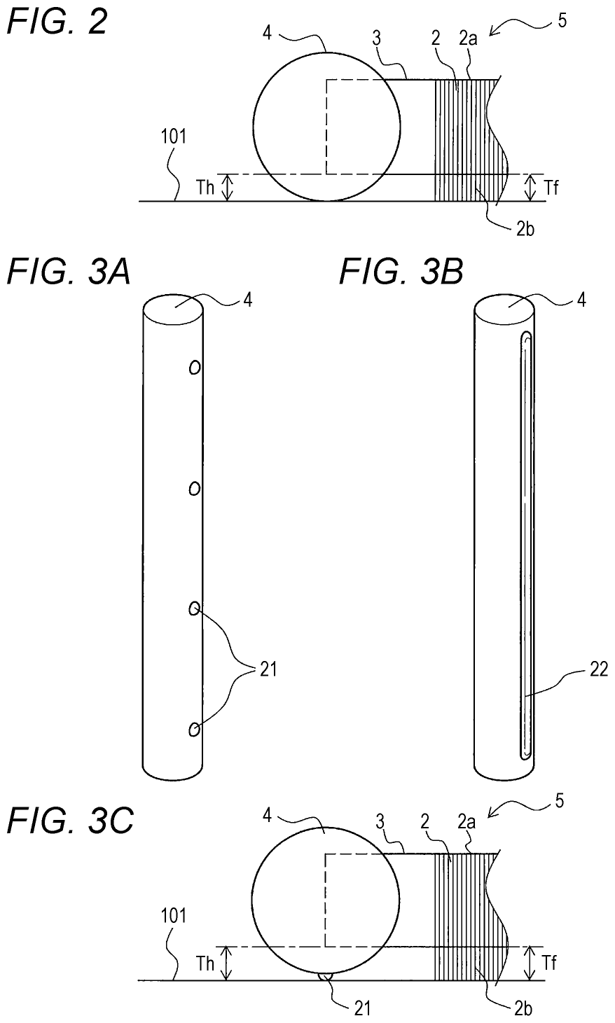

First, for forming the less-deformable heat exchanger 1 as described above, the protruding length Th of the fin 2 from the heat transfer pipe 3 and a distance from the heat transfer pipe 3 to an outer surface of the header 4 on the same side as the protrusion are set substantially equal to each other as illustrated in FIG. 2. Next, the heat exchanger manufacturing method for manufacturing the less-deformable heat exchanger 1 as described above will be described. In this manufacturing method, an assembled member 5 including the fins 2, the heat transfer pipes 3, and the headers 4 is joined by furnace brazing.

(First Step)

The heat transfer pipes 3, the fins 2, and the headers 4 are temporarily assembled as in the above-described structure to form the assembled member 5. The size of each portion of each member described herein is, by assembly, set such that the protruding length Tf of the fin 2 from the heat transfer pipe 3 and the distance Th from the heat transfer pipe 3 to the outer surface of the header 4 on the same side as the protrusion are substantially equal to each other (FIG. 2).

(Second Step)

As illustrated in FIG. 2, the assembled member 5 lies down, after the first step, such that a protruding length Tf side and a distance Th side are on a lower side and longitudinal directions of the headers 4 and the fins 2 are along the horizontal direction, and then, is placed on a conveyer 101. Note that the first step can be performed with the assembled member 5 lying down as described above. Alternatively, the first step may be performed on the conveyer 101. Note that not the assembled member 5 curved in the L-shape as illustrated in FIG. 1 but the linear assembled member 5 is placed on the conveyer 101. Curving in the L-shape as illustrated in FIG. 1 is performed by a step after a subsequent third step. When the linear assembled member 5 is placed on the conveyer 101, the linear assembled member 5 is placed on the conveyer 101 with a protruding portion 2b (FIG. 2) side thereof facing down.

(Third Step)

After the second step, the assembled member 5 is conveyed into a furnace by the conveyer 101, and then, is heated for furnace brazing of the assembled member 5. Note that a brazing material is formed in advance on surfaces of the heat transfer pipes 3 or the fins 2 and surfaces of the headers 4. Thereafter, when the brazing material is cooled, the heat transfer pipes 3 are firmly joined to the fins 2 and the headers 4.

According to the heat exchanger manufacturing method and the heat exchanger 1 described above, the protruding length Tf of the fin 2 from the heat transfer pipe 3 and the distance Th from the heat transfer pipe 3 to the outer surface of the header 4 on the same side as the protrusion are set substantially equal to each other. Thus, a contact surface of the heat exchanger 1 (the assembled member 5) with a transportation unit such as the conveyer 101 for performing furnace brazing is in uniform contact. That is, the heat transfer pipes 3 are not inclined to one side, but are parallel to the conveyer 101. Thus, the amount of inclination of the fins 2, the heat transfer pipes 3, and the headers 4 can be decreased. Thus, the heat exchanger manufacturing method and the heat exchanger 1 can be provided such that each member is less inclined even when these members are joined by furnace brazing.

As described above, the amount of deformation of the fins 2, the heat transfer pipes 3, and the headers 4 can be suppressed low, and therefore, the well-looking heat exchanger 1 exhibiting favorable assemblability and leading to less occurrence of a clearance as a cause for degradation of performance of the heat exchanger 1 can be provided. Further, in a case where each heat transfer pipe 3 as the flat pipe is inserted into the fins 2 as in the present embodiment (see FIG. 1B), the present embodiment provides a significant effect that residual stress of the fins 2 and the heat transfer pipes 3 upon temporal assembly is relatively great and each member is less inclined. In a case where the heat transfer pipes 3 are the flat pipes (see FIG. 1B) and the direction of insertion of the heat transfer pipe 3 into the fin 2 is not perpendicular but inclined (see FIG. 1A) as in the present embodiment, the present embodiment provides a significant effect that residual stress is easily applied to the fins 2 and the heat transfer pipes 3 and each member is less inclined. Note that even when the direction of insertion of the heat transfer pipe 3 into the fin 2 is perpendicular, the effect that each member is less inclined is also provided.

### Second Embodiment

In an embodiment below, reference numerals similar to those of the first embodiment are used to represent members and the like common to those of the first embodiment, and detailed description thereof will be omitted. First, a difference of the second embodiment from the first embodiment is that multiple substantially-hemispherical small raised portions 21 arranged at equal intervals are, for example, formed in line in a longitudinal direction of a header 4 at an outer surface of the header 4 as illustrated in FIG. 3A.

Alternatively, a thin straight line-shaped raised portion 22 may be formed in the longitudinal direction of the header 4 at the outer surface of the header 4 as illustrated in FIG. 3B. As illustrated in FIG. 3C, when an assembled member 5 is formed, the raised portions 21 or the raised portion 22 are formed on the same side as a protrusion with a protruding length Tf at the header 4. Thus, the header 4 contacts a conveyer 101 through the raised portions 21 or the raised portion 22. In addition, the protruding length Tf and a distance Th are set substantially equal to each other, a length from a heat transfer pipe 3 to a tip end of the raised portion 21 (22) being taken as the distance Th. According to the present embodiment, advantageous effects similar to those of the first embodiment can be provided.

Moreover, in the present embodiment, the raised portions 21 (or the raised portion 22) as dot-shaped or linear protrusions are provided on a lower side of the header 4 in brazing. Thus, the header 4 and the conveyer 101 contact each other only through the raised portions 21 (or the raised portion 22), and therefore, the contact area of the header 4 with the conveyer 101 can be decreased. Consequently, degradation of an outer appearance of the assembled member 5 due to re-solidifying of brazing material drops can be reduced.

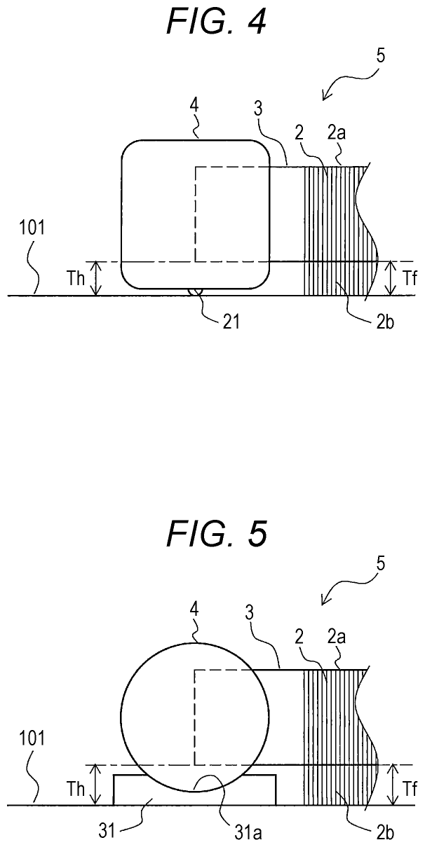

Note that when the conveyer 101 is in a mesh shape, the raised portions 21 as the dot-shaped protrusions might be dropped in a mesh, and for this reason, the raised portion 22 as the linear protrusion is preferably used. FIG. 4 is a variation of the present embodiment. A difference of an example of FIG. 4 from the embodiment of FIG. 3 is the sectional shape of the header 4 in a radial direction. In the example of FIG. 4, the sectional shape of the header 4 in the radial direction is a substantially rectangular shape with round-chamfered corner portions. In this case, the raised portions 21 (or the raised portion 22) are provided on the lower side of the header 4 in brazing.

FIG. 5 is another variation of the second embodiment. A difference of an example of FIG. 5 from the embodiment of FIG. 3 is that a plate-shaped seat 31 is used instead of the raised portions 21 and the raised portion 22. For the seat 31, a direction perpendicular to the plane of paper of FIG. 5 is a plate thickness direction, and an upper-to-lower direction of the plane of paper is a plate width direction. A cutout 31a matching the outer shape of the header 4 is formed at an upper portion of the seat 31, and the header 4 is fitted in the cutout 31a such that the header 4 is supported on the seat 31. Multiple plate-shaped seats 31 are arranged at certain intervals in the direction perpendicular to the plane of paper of FIG. 5, and support the header 4 from below at multiple spots in the longitudinal direction of the header 4. Moreover, the protruding length Tf and the distance Th are set substantially equal to each other, a length from the heat transfer pipe 3 to a lower end of the seat 31 being taken as the distance Th. Note that for avoiding brazing of the seat 31 to the header 4, the seat 31 is preferably made of a material different from those of the header 4 and the like.

In the variation of FIG. 5, contact of the header 4 with the conveyer 101 can be eliminated, and therefore, degradation of the outer appearance of the assembled member 5 due to re-solidifying of the brazing material drops can be reduced. Moreover, the raised portions 21 (or the raised portion 22) are not necessarily provided at the header 4 as in the examples of FIGS. 3 and 5, and therefore, placement of a component unnecessary for a heat exchanger 1 as a completed product can be prevented.

### Third Embodiment

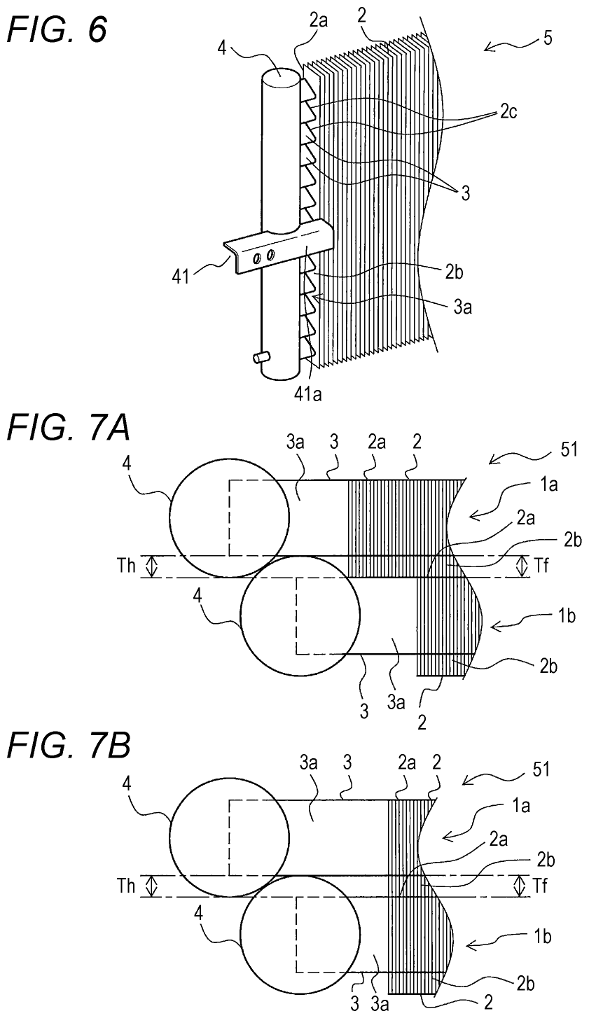

A difference of a third embodiment from the second embodiment is that an attachment member 41 for attaching a header 4 and therefore a heat exchanger 1 to a housing of an outdoor unit of an air-conditioner is used as illustrated in FIG. 6 instead of the raised portions 21, the raised portion 22, and the seat 31. That is, the attachment member 41 is attached to the header 4, and is provided as substitute for the seat 31. A protruding length Tf and a distance Th are set substantially equal to each other, a length from a heat transfer pipe 3 to an end portion 41a of a protruding portion of the attachment member 41 being taken as the distance Th. The attachment member 41 described herein is preferably made of the same type of material as that of the header 4 because the attachment member 41 is brazed to the header 4.

According to the present embodiment, contact of the header 4 with a conveyer 101 can be eliminated, and therefore, degradation of an outer appearance of an assembled member 5 due to re-solidifying of brazing material drops can be reduced. Moreover, the seat also serves as the attachment member 41, and therefore, assemblability of the outdoor unit of the air-conditioner can be improved.

### Fourth Embodiment

A fourth embodiment relates to the heat exchanger stacking method for stacking heat exchangers 1, which are assembled by brazing as described above, one above the other and a multi-row heat exchanger. FIG. 7A illustrates a multi-row heat exchanger 51. The heat exchangers 1 manufactured in the first embodiment or the second embodiment are often used in multiple rows (see FIG. 8). The multi-row heat exchanger 51 is intended to enhance the degree of adhesion between two heat exchangers 1.

As described above, a fin 2 protrudes from a heat transfer pipe 3 on one side of each fin 2 (a protruding portion 2b), but does not protrude from the heat transfer pipe 3 on the other side (a side portion 2a). In the present embodiment, the protruding length Tf of the fin 2 from the heat transfer pipe 3 and a distance Th from the heat transfer pipe 3 to an outer surface of a header 4 on a side opposite to the protrusion are set substantially equal to each other. In an example of FIG. 7, the distance Th from the heat transfer pipe 3 to the outer surface of the header 4 on the same side as the protrusion with the protruding length Tf is also set equal to the protruding length Tf.

Two heat exchangers 1, i.e., a heat exchanger 1a and a heat exchanger 1b, are prepared. As illustrated in FIG. 7A, the heat exchanger 1a and the heat exchanger 1b are stacked one above the other with the heat exchanger la being on an upper side and the heat exchanger 1b being on a lower side. In this state, the fins 2 are set such that tip end portions of the protruding portions 2b of the heat exchanger 1a and tip end portions of the heat exchanger 1b on a non-protruding side (a side portion 2a side) contact each other. Moreover, these two heat exchangers are stacked one above the other in a state in which the headers 4 of the heat exchanger 1b of which fins 2 contact other fins 2 on the non-protruding side contact sections 3a , where no fins 2 are provided, of the heat transfer pipes 3 of the heat exchanger 1a. By such stacking, some of the fins 2 of the heat exchanger la do not contact the fins 2 of the heat exchanger 1b, and the headers 4 of the heat exchanger 1a and the headers 4 of the heat exchanger 1b are offset from each other in a residual flow direction in FIG. 7A.

Note that in the example of FIG. 7A, both of the heat exchanger 1a and the heat exchanger 1b have the protruding portions 2b facing down, and the headers 4 of the heat exchanger 1b positioned on the lower side contact the sections 3a of the heat exchanger 1a positioned on the upper side. However, the present embodiment is not limited to such a configuration. The protruding portions 2b of both of the heat exchanger 1a and the heat exchanger 1b may face up, and the headers 4 of the heat exchanger 1a positioned on the upper side may contact the sections 3a of the heat transfer pipes 3 of the heat exchanger 1b positioned on the lower side.

A difference of the example of FIG. 7B from FIG. 7A is that the heat exchanger lb has a shorter distance of the section 3a, where no fins 2 are formed, of the heat transfer pipe 3 than that of the heat exchanger la and the fins 2 of the heat exchanger 1a and the fins 2 of the heat exchanger 1b have no portions where the fins 2 do not contact the fins 2 of the other heat exchangers. FIG. 8 includes a perspective view FIG. 8A and an upper view FIG. 8B of the entirety of the multi-row heat exchanger 51 of FIG. 7A. According to the multi-row heat exchanger 51 of the present embodiment, a clearance between the row of the heat exchanger la and the row of the heat exchanger 1b is less caused, and therefore, the degree of adhesion can be enhanced. Thus, in a case where the multi-row heat exchanger 51 is directly placed at an outdoor unit of an air-conditioner, the multi-row heat exchanger 51 can exhibit a high degree of adhesion between the heat exchangers 1. Thus, a high-performance heat exchanger exhibiting favorable assemblability and having a high density and a small ground contact area can be provided.

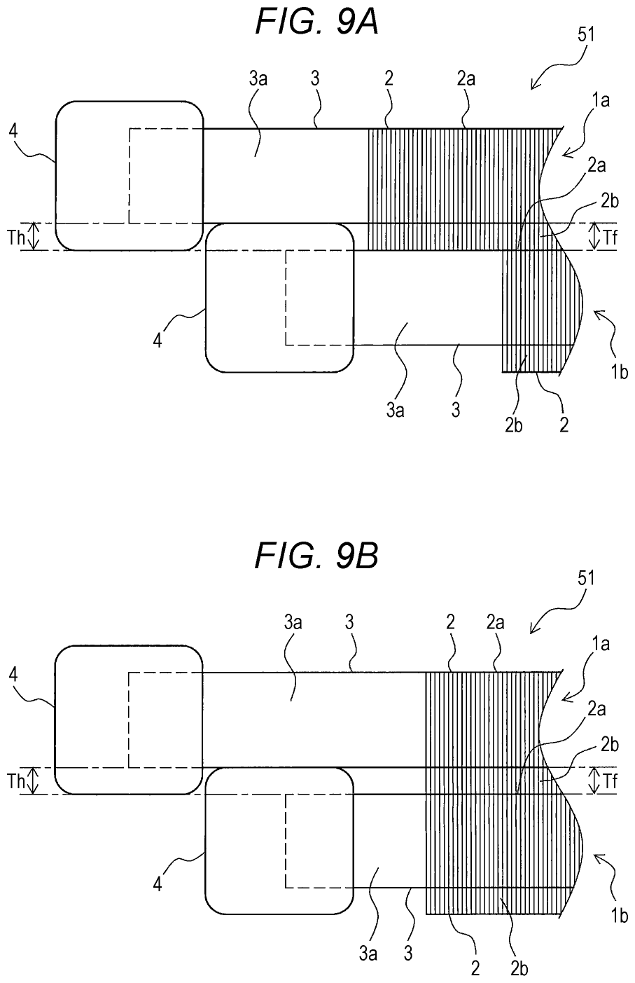

FIGS. 9A and 9B are each variations of FIGS. 7A and 7B, and are different in that the sectional shape of the header 4 in a radial direction is a substantially rectangular shape with round-chamfered corner portions. Note that heat exchangers 1 including raised portions 21 or a raised portion 22 at each header 4 as in the second embodiment may be used to form the multi-row heat exchanger 51. As long as no interference with stacking of the heat exchangers 1 is caused, heat exchangers 1 including attachment members 41 as in the third embodiment may be used.

Note that the present disclosure is not limited to the above-describe embodiments, and includes various modifications. For example, the above-described embodiments have been described in detail for the sake of simplicity in description of the present embodiment, and the present embodiment is not limited to one including all configurations described above. Moreover, some of configurations of a certain embodiment can be replaced with configurations of other embodiments, and configurations of other embodiments can be added to configurations of a certain embodiment. Moreover, addition/omission/replacement of other configurations can be made to some of configurations of each embodiment.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A heat exchanger manufacturing method for manufacturing a heat exchanger by brazing of multiple heat transfer pipes, multiple fins, and headers, the heat exchanger including
the multiple fins arranged in a thickness direction,
the multiple heat transfer pipes joined to each fin with the heat transfer pipes each being inserted into cutout recessed portions as cutouts of side portions of the fins on one side, and
the headers each joined to both end portions of each heat transfer pipe to couple the multiple heat transfer pipes and having internal spaces for collecting or distributing fluid flowing in the multiple heat transfer pipes, the method comprising:
a first step of assembling the heat transfer pipes, the fins, and the headers to form an assembled member and setting such that a protruding length Tf of each fin from a corresponding one of the heat transfer pipes and a distance Th from each heat transfer pipe to an outer surface of a corresponding one of the headers on the same side as a protrusion are substantially equal to each other;
a second step of placing, after the first step, the assembled member on a conveyer with the protruding length Tf side and the distance Th side facing down; and
a third step of conveying, after the second step, the assembled member into a furnace by the conveyer to heat the assembled member, thereby performing brazing of the assembled member.

2. The heat exchanger manufacturing method according to claim 1, wherein
an attachment member configured to attach each header to a housing of an outdoor unit of an air-conditioner is provided at each header,
at the second step, each header is placed on the conveyer with the attachment member facing down, and
a distance from each heat transfer pipe to an end portion of a protruding portion of the attachment member is the distance Th.

3. A heat exchanger stacking method for stacking two heat exchangers one above the other, each heat exchanger including
multiple fins arranged in a thickness direction,
multiple heat transfer pipes joined to each fin with the heat transfer pipes each being inserted into cutout recessed portions as cutouts of side portions of the fins on one side and configured such that the fins protrude from one side in a radial direction and do not protrude from the other side, and
headers each joined to both end portions of each heat transfer pipe to couple the multiple heat transfer pipes and having internal spaces for collecting or distributing fluid flowing in the multiple heat transfer pipes, wherein
each heat exchanger is configured such that a protruding length Tf of each fin from a corresponding one of the heat transfer pipes and a distance Th from each heat transfer pipe to an outer surface of a corresponding one of the headers on a side opposite to a protrusion are substantially equal to each other,
a heat transfer pipe section where no fins are provided is present between each header and a corresponding one of the fins, and
the two heat exchangers are stacked one above the other in a state in which the fins of one of the two heat exchangers on a protruding side from the heat transfer pipes contact the fins of the other one of the two heat exchangers on a non-protruding side and the headers of one of the two heat exchangers on the non-protruding side contact the heat transfer pipe sections of the other one of the two heat exchangers.

4. A multi-row heat exchanger comprising:
two heat exchangers,
wherein each heat exchanger includes
multiple fins arranged in a thickness direction,
multiple heat transfer pipes joined to each fin with the heat transfer pipes each being inserted into cutout recessed portions as cutouts of side portions of the fins on one side and configured such that the fins protrude from one side in a radial direction and do not protrude from the other side,
headers each joined to both end portions of each heat transfer pipe to couple the multiple heat transfer pipes and having internal spaces for collecting or distributing fluid flowing in the multiple heat transfer pipes,
a protruding length Tf of each fin from a corresponding one of the heat transfer pipes and a distance Th from each heat transfer pipe to an outer surface of a corresponding one of the headers on a side opposite to a protrusion are substantially equal to each other,
a heat transfer pipe section where no fins are provided is present between each header and a corresponding one of the fins, and
the two heat exchangers are stacked one above the other in a state in which the fins of one of the two heat exchangers on a protruding side from the heat transfer pipes contact the fins of the other one of the two heat exchangers on a non-protruding side and the headers of one of the two heat exchangers on the non-protruding side contact the heat transfer pipe sections of the other one of the two heat exchangers.
